(19) United States
(12) Patent Application Publication
(10) Pub. No.: US 2015/0195398 A1
(43) Pub. Date: Jul. 9, 2015

(54) COLLISION AVOIDANCE SYSTEM FOR ELECTRONIC HANDHELD DEVICES

(71) Applicants: Eric Schimpff, Strongsville, OH (US); Richard Park Andersen, San Jose, CA (US)

(72) Inventors: ERIC SCHIMPFF, Strongsville, OH (US); Richard Park Andersen, San Jose, CA (US)

(21) Appl. No.: 14/588,951

(22) Filed: Jan. 4, 2015

Related U.S. Application Data
(60) Provisional application No. 61/923,660, filed on Jan. 4, 2014.

(51) Int. Cl. H04M 1/725; G08G 1/16

(52) U.S. Cl. CPC H04M 1/72569; G08G 1/164

(57) ABSTRACT

The invention provides a collision avoidance system built into a case, which accommodates a screen-based electronic handheld device. The system includes either an integrated viewing camera or other sensor independent from the electronic handheld device or a mechanism to utilize a viewing camera or other sensor which is integrated into the device by the device manufacturer.

### REFERENCE TO RELATED APPLICATION

This application is based on, and claims the benefit of priority to, U.S. provisional application Ser. No. 61/923,660, entitled “Collision Avoidance System for Electronic Handheld Devices” filed on Jan. 4, 2014, and U.S. provisional application Ser. No. 61/923,659, entitled “Collision Avoidance System for Mobile Devices” filed on Jan. 4, 2014, the content of which being incorporated in its entirety by reference herein.

### FIELD OF THE INVENTION

This invention generally relates to a system for preventing pedestrians from colliding with obstacles while interacting with their electronic handheld devices. More particularly, this invention relates to a system providing a collision detection mode on an electronic handheld device for preventing pedestrian collisions with obstructions.

### BACKGROUND OF THE INVENTION

In 2011, US Department of Transportation reported 4,432 pedestrian deaths and an estimated 69,000 pedestrian injuries in the United States. “Traffic Safety Facts” NHTSA's National Center for Statistics and Analysis, DOT HS 811748, pg 1, August 2013. Researchers have discovered a correlation between pedestrian cell phone use and reduced situational awareness. Jack L. Nasara, Derek Troyer. “Pedestrian injuries due to mobile phone use in public places” Accident Analysis and Prevention 57 (2013) pg 91, Elsevier Ltd. 2013. The gravity of this problem is serious considering that estimates of total pedestrian injuries have decreased, but mobile phone related injuries have increased. Id. at 93.

Legislators have taken on the problem by passing new laws. In 2011, California nearly passed a ban on the use of cell phones or other wireless devices while operating a bicycle, but the bill was vetoed by the governor. California Senate Bill 28. At least one New Jersey police officer has turned to enforcing jaywalking laws to prevent texters from injuring themselves. “Study: Distracted Pedestrian Deaths, Injuries On The Rise” CBS New York, CBS Local Media. 2013. Some cities have reverted to writing messages on the sidewalk and crosswalks that say, “Look up.” Id. Clearly, a solution is desired for reducing the number of injuries caused by pedestrian cell phone use.

Collision avoidance systems have been proposed for automotive vehicles in various formats. See “Taking the Crush Out of Rush Hour”, High Technology Business, March, 1989, pages 26-30; and “Laser Ranging Device Keeps Cars Apart”, Winfried Arndt, Photonics Spectra, July 1990, pages 133-134. Some systems use radar tracking, which provides range information by measuring the time delay between transmission of a radio frequency pulse and detection of the pulse reflected from a distant object. Radar systems are capable of determining vehicle velocity using the Doppler principle. These radar systems suffer from a lack of good spatial resolution, and require a large antenna to obtain good resolution. At 94 GHz, an antenna size of 372 millimeters is required to obtain one-degree beam resolution. The antenna size is inappropriate for implementation on a cell phone.

A technique for avoiding automobile collisions employs an electro-optical scanning system as disclosed in U.S. Pat. No. 5,249,157. This electro-optical system transmits light pulses via a laser diode to all pixels in the field of view and receives and detects returned signals in such a manner that range and angle information is obtained. A rotating scanning disc detects the return light from a scene to be scanned, and a series of mirrors are used focus the scene line by line in the vertical segments. The laser diode emits a 20 nanosecond light pulse, which is reflected from a vehicle back to the subject vehicle. Upon return of the reflected signal, the reflected pulse is focused onto the detector array and is detected. Because the scanning disc rotates at a constant speed, the rotational distance traveled by the scanning disc can be compared with the elapsed time required for a transmitted pulse to reflected and return to compute the range of a target vehicle. The target angle is calculated from the position of the corresponding pixel in the scanned field taking into account the time lapse between the start of a frame scan and the particular pixel being scanned.

Another known method for preventing automobile collisions is using gray-scale stereo cameras. Sergiu Nedevschi, Silviu Bota, and Corneliu Tomiuc. “Stereo-Based Pedestrian Detection for Collision-Avoidance Applications” IEEE Transactions on Intelligent Transportation Systems, VOL. 10, NO. 3, September 2009. In this system, two images are taken from different angles and then stereo matched to generate a set of 3D points. Id. The 3D object is projected into a 2D image, which is then compared to pedestrian images. Objects that are not determined to be pedestrians are filtered out. Id. Pedestrian images are tracked, and further tested over time by analyzing for moving body parts, especially swinging arms and moving legs.

Widely adopted electronic handheld devices and smart phones, such as Apple iPhones, iPods and iPads or Nokia electronic handheld phones running Microsoft Windows or Samsung electronic handheld phones or tablets running Android are used very frequently in a manner requiring visual concentration on a display screen as they interact with applications such as the address book, telephone dialer, SMS/Texting, Map/GPS navigation, magazine or book reader, web browser, email client, music player, etc. The users also are frequently using these devices while in crowded locations (e.g. cities, airports, shopping malls, event centers) or crossing streets or simply walking where there are potential obstacles or obstructions. As a result, users of these devices are experiencing collisions with other pedestrians, motorized and non-motorized vehicles, and stationary obstacles. In addition, the users may trip or fall as a result of not observing either something in their path or something moving toward them. The risk of being injured, causing injury, or even being the catalyst for physical property damage is significant and increasing as screen-based electronic handheld devices proliferate.

Therefore, it would be desirable to provide a collision avoidance system for electronic handheld devices.

### SUMMARY OF THE INVENTION

The current invention provides for obstruction detection and collision avoidance on electronic handheld devices by employing a sensing mechanism, a processor, and software to process the information captured by the sensing mechanism for display on the electronic handheld device. Electronic handheld devices include but are not limited to touch screen cell phones, non-touch screen cell phones, PDAs, tablets, handheld game systems, handheld televisions, e-readers, GPS units, watches, mp3 players, and netbooks.

The current invention further envisions a collision avoidance system built into a case, which accommodates a screen-based electronic handheld device. The system includes either an integrated sensing mechanism that is an integrated viewing camera or other sensor independent from the electronic handheld device or a sensing mechanism that utilizes a viewing camera or other sensor that is integrated into the device by the device manufacturer. The case of the system can have shock absorption, stylistic design, or other common features similar to existing cases on the market.

In one preferred embodiment of the invention, a process for providing an integrated, end-user operable collision avoidance system is disclosed. The process comprises the following steps: integrating an separate sensing and collision avoidance system with a electronic handheld device; receiving data about the available surrounding area via the sensing mechanism; modifying or enhancing the data available to the sensing mechanism as it is being received by the sensing mechanism, transmitting data from the sensing mechanism to the electronic handheld computing process through a transmission mechanism, interpreting data being received from the transmission mechanism in the form of information that can be displayed back to the device user, enhancing the information received from the sensing mechanism using additional information from the user or the device or additional data sources or additional applications, and displaying information to the user by means of a user interface.

In another preferred embodiment of the invention, the system contains an integrated mechanism that is dependent upon the electronic handheld device sensor, and is connected to the electronic handheld device via an electronic interface. Hardware augmentations are integrated into the invention and are connected to the electronic handheld device via the electronic interface. The system contains the following components: a sensing mechanism for receiving sensing data about the area available to the sensing mechanism; a means for modifying or enhancing data available for the sensing mechanism; a means for activating and deactivating the sensing mechanism; a transmission mechanism; a means for interpreting sensing data; a means for enhancing data by the means of interpreting data; and a user interface means for managing display of information.

In yet another preferred embodiment of the invention, the system interfaces and utilizes a sensing mechanism provided by the electronic handheld device manufacturer, such as a built-in camera, and provides necessary hardware and software augmentation to provide the required collision avoidance capabilities. The hardware augmentations are integrated into the invention, are not connected to the electronic handheld device via an electronic interface, and work in conjunction with the electronic handheld device sensing mechanism. Enabling the hardware augmentation requires a manual step by the electronic handheld device user. The system contains the following components: a means for interfacing with and utilizing the electronic handheld device sensing mechanism; a means for augmenting the sensing mechanism; a transmission mechanism; a means for interpreting sensing data; a means for enhancing data by the means of interpreting data; and a user interface means for managing the display of information.

### BRIEF DESCRIPTION OF THE DRAWINGS

FIG. 1 is a schematic diagram illustrating the collision avoidance system according to one preferred embodiment of the present invention.

FIG. 2 is a schematic diagram illustrating the user interface according to one preferred embodiment of the present invention.

FIG. 3 is a schematic diagram illustrating the collision avoidance system according to one preferred embodiment of present invention.

FIG. 4 is a schematic diagram illustrating various aspects of the information display mechanism 401 according to one preferred embodiment of present invention.

FIG. 5 is a flowchart illustrating a process for operating the collision avoidance system according to one preferred embodiment of the present invention.

FIG. 6A and FIG. 6B are photographic illustrations of the collision avoidance system, which contain the user interface means and the “layered” mode according to the invention.

FIG. 7 is a photographic illustration of the collision avoidance system, containing the user interface means a display band which is displayed at the top of the screen in this photograph.

FIG. 8 is a schematic illustration of a Handheld Electronic Device Case with a camera/sensing mechanism on top for avoiding collisions according to the present invention.

FIG. 9A is a schematic illustration of a back view of a Handheld Electronic Device Case with a camera/sensing mechanism on top for avoiding collisions according to the present invention.

FIG. 9B is a schematic illustration of a side view of a Handheld Electronic Device Case with a camera/sensing mechanism on top for avoiding collisions according to the present invention.

FIG. 10 is a schematic illustration of a of a Handheld Electronic Device Case with a camera/sensing mechanism or refracting mechanism on back for avoiding collisions according to the present invention.

FIG. 11A is a schematic illustration of a back view of a Handheld Electronic Device Case with a camera/sensing mechanism or refracting mechanism on back for avoiding collisions according to the present invention.

FIG. 11B is a schematic illustration of a side view of a Handheld Electronic Device Case with a camera/sensing mechanism or refracting mechanism on back for avoiding collisions according to the present invention.

FIG. 12 is a schematic illustration of a Handheld Electronic Device Case with a refracting mechanism on back for avoiding collisions according to the present invention.

FIG. 13A is a schematic illustration of a back view of a Handheld Electronic Device Case with a refracting mechanism on back for avoiding collisions according to the present invention.

FIG. 13B is a schematic illustration of a side view of a Handheld Electronic Device Case with a refracting mechanism on back for avoiding collisions according to the present invention.

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

The present invention is a collision avoidance system built into a case, which accommodates a screen-based electronic handheld device. The system includes either a sensing mechanism with an integrated viewing camera or other sensor independent from the electronic handheld device or a sensing mechanism that utilizes a viewing camera or other sensor that is integrated into the device by the device manufacturer. The case of the system can have shock absorption, stylistic design, or other common features similar to existing cases on the market.

In one preferred embodiment of the invention, the system contains a sensing mechanism that is independent from the electronic handheld device. The system contains the following components: a sensing mechanism for receiving sensing data about the area available to the sensing mechanism; a module for modifying or enhancing data available for the sensing mechanism; a means for activating and deactivating the sensing mechanism; a transmission mechanism; a means for interpreting sensing data; a means for enhancing data by the means of interpreting data; and a user interface means for managing the display of information manually or automatically.

In another preferred embodiment of the invention, the system interfaces and utilizes a manufacturer or third-party integrated sensing mechanism. The system contains the following components: a means for interfacing with and utilizing the integrated sensing mechanism; a means for augmenting the sensing mechanism; a transmission mechanism; a means for interpreting sensing data; a means for enhancing the interpreted data; and a user interface means for managing display of information.

In another preferred embodiment of the invention, a process for operating a collision avoidance system is disclosed. The process comprises the following steps: attaching a collision avoidance system which is dependent upon an electronic handheld device; receiving data about the available area by utilizing a sensing mechanism; modifying or enhancing data available to the sensing mechanism as it is being received by the sensing mechanism by means of modifying or enhancing data; receiving data from the sensing mechanism by utilizing a transmission mechanism; transmitting data from the sensing mechanism to the electronic handheld computing process through a transmission mechanism; interpreting data being received from the transmission mechanism by a means of interpreting data in the form of information that can be displayed back to the device user; enhancing the information received from the sensing mechanism by a means of enhancing information using additional information from the user or the device or additional data sources or additional applications; and displaying information to the user by means of a user interface.

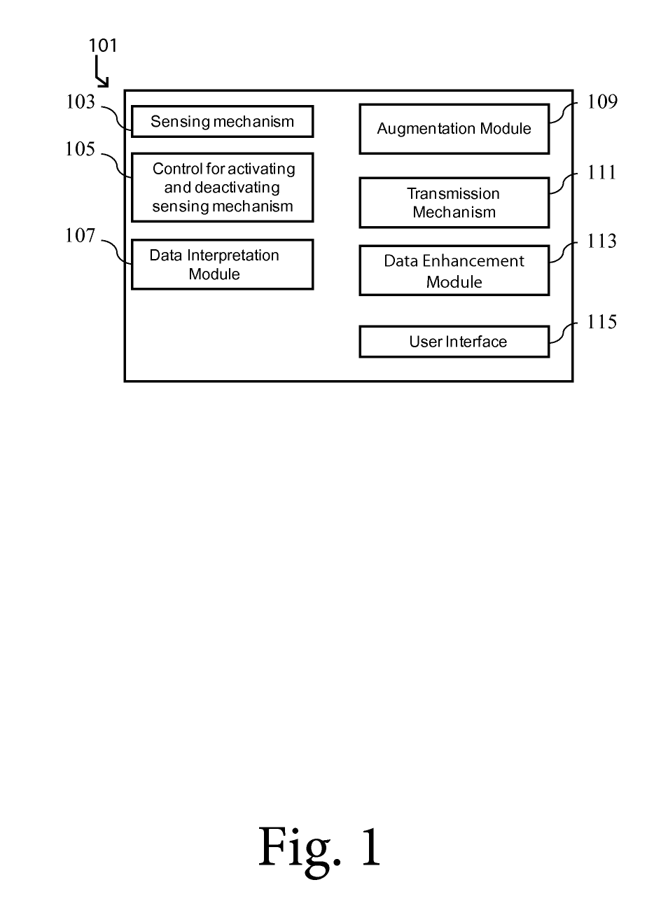

FIG. 1 is a schematic diagram illustrating the collision avoidance system 101 according to one preferred embodiment of the present invention. The collision avoidance system 101 comprises: a sensing mechanism 103, such as an optical sensor, for receiving sensing data about the area available to the sensing mechanism; a means for modifying or enhancing data, such as an augmentation module 109 available for the sensing mechanism 103; a control 105 for activating and deactivating the sensing mechanism 101; a transmission mechanism 111; a data interpretation module 107; a data enhancement module 113; a data interpretation module 109; and a user interface 115 for managing the displayed of information.

The collision avoidance system 101 receives data about the area available to the sensing mechanism 103. The sensing mechanism 103 can be a viewing camera or sensor.

The augmentation module 109, available to the sensing mechanism 103, functions as data is received by the sensing mechanism 103 by utilizing optical components such as may be done with analog or digital optical refraction techniques independently or in combination with electronic or logical manipulation. The augmentation module 109 can contain computer software that utilizes the sensing mechanism 103 to perform the function to modify or enhance the data available to the sensing mechanism 103.

The control 105 for activating and deactivating sensing mechanism 103 is implemented as a hardware or/and software switching mechanism to activate or deactivate the collision avoidance system 101.

The transmission mechanism 111 receives data from the sensing mechanism 103 and transmits the data to an electronic handheld device computing processor that the system 101 is attached to. The data interpretation module 107 interprets sensing data being received from the transmission mechanism 111 in the form of information that can be displayed back to the device user. The data interpretation module 107 can be computer software or computer hardware or a combination of both. The data enhancement module 113 is utilized in conjunction with the data interpretation module 107 to enhance the information received from the sensing mechanism 103 and in addition may utilize additional information from the user or the device or additional data sources or additional applications.

The user interface 115 manages the display of information for the device user, any user-configurable parameters associated with the display of information, and any user feedback instructions received during the activation or use of the system at any time.

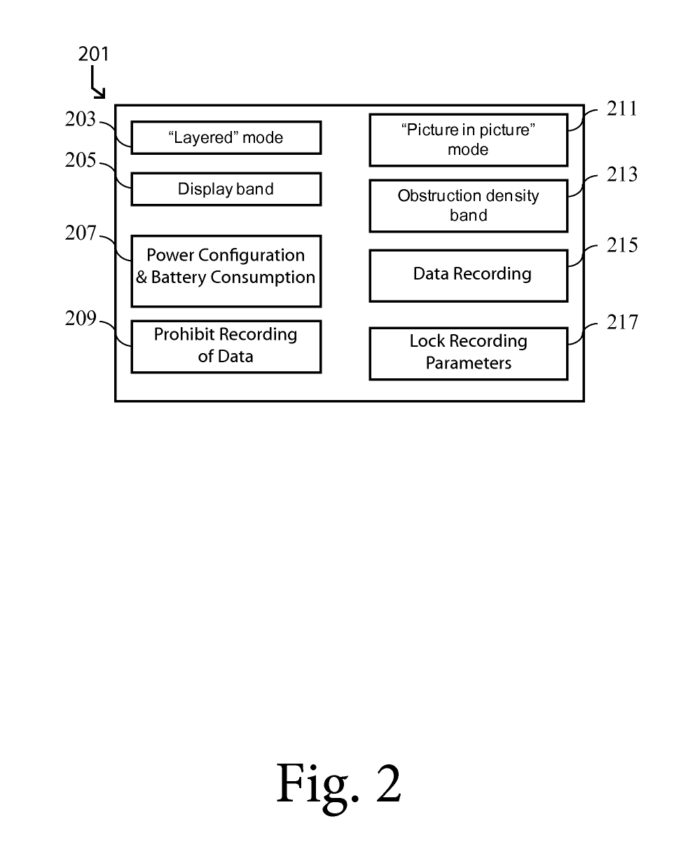

FIG. 2 is a schematic diagram illustrating the user interface 115 according to one embodiment of the present invention. The user interface 201 comprises any combination among a plurality of components. The plurality of components include: a “layered” mode 203 component, a “picture in picture” mode 211 component, a display band 205 component, and an obstruction density band 213 component, a power configuration and battery consumption 207 component , a data recording 215 component, a prohibit recording of data 209 component, and a lock recording parameters 217 component. The “layered” mode 203 incorporates a background layer for the display of information useful for collision avoidance and one or more application's primary interface in the foreground layer. Either the foreground or background layer may be made brighter or dimmer by varying the opacity of either. The “picture in picture” mode 211 is similar to what is found on televisions. The display band 205 is displayed at the top of the screen or can be repositioned by the user. The obstruction density band 213 is displayed at the top of the screen or can be repositioned by the user. It displays information similar to the way radar systems display information. The user may adjust brightness and vary the opacity of the various information display elements. The power configuration and battery consumption 207 component may contain a low-power option that may utilize a different sensing or digital sampling algorithm, or user-configurable brightness or other parameters. The data recording 215 component records a variable amount of data received by the sensing mechanism 103. The “prohibit recording of data” 209 component prohibits any recording of data received by the sensing mechanism 103. The lock recording parameters 217 component locks data recording parameters in such a manner so that it would not be a user configurable option.

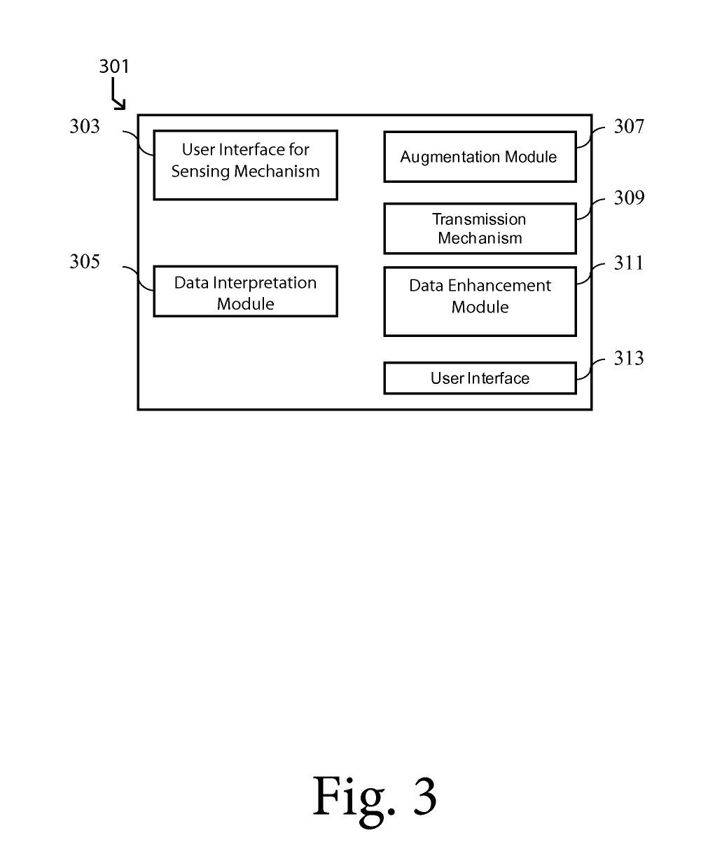

FIG. 3 is a schematic diagram illustrating the collision avoidance system 301 according to another preferred embodiment of the present invention. The collision avoidance system 301 interfaces and utilizes a manufacturer or third-party integrated sensing mechanism on the electronic handheld device. The collision avoidance system 301 comprises: a user interface 303 for interfacing with and utilizing the integrated sensing mechanism; an augmentation module 307 for the sensing mechanism; a transmission mechanism 309; a data interpretation module 305; a data enhancement module 311; and a user interface 313 for managing display of information.

The user interface for the sensing mechanism 303 interfaces with and utilizes a manufacturer or third-party integrated sensing mechanism to receive data about the area available to the sensing mechanism. The sensing mechanism can be a viewing camera or sensor.

The augmentation module for the sensing mechanism 307 augments the sensing mechanism by utilizing optical components or manipulation logic such as may be done with analog or digital optical refraction techniques to modify or enhance data available to the sensing mechanism or as it is being received by the sensing mechanism. The augmentation module 307 can contain computer software that can be utilized by the sensing mechanism to perform the function of modifying or enhancing the data available to the sensing mechanism.

The transmission mechanism 309 receives data from the sensing mechanism and transmits the data to an electronic handheld device computing processor that the system 301 is attached to. The data interpretation module 305 interprets sensing data being received from the transmission mechanism 309 in the form of information that can be displayed back to the device user. The data interpretation module 305 can be computer software or computer hardware. The data enhancement module is used by the data interpretation module 305 to enhance the information received from the sensing mechanism using additional information from the user or the device or additional data sources or additional applications.

The user interface 313 manages the display of information for the device user, any user-configurable parameters associated with the display of information, and any user feedback instructions received during the activation or use of the system at any time.

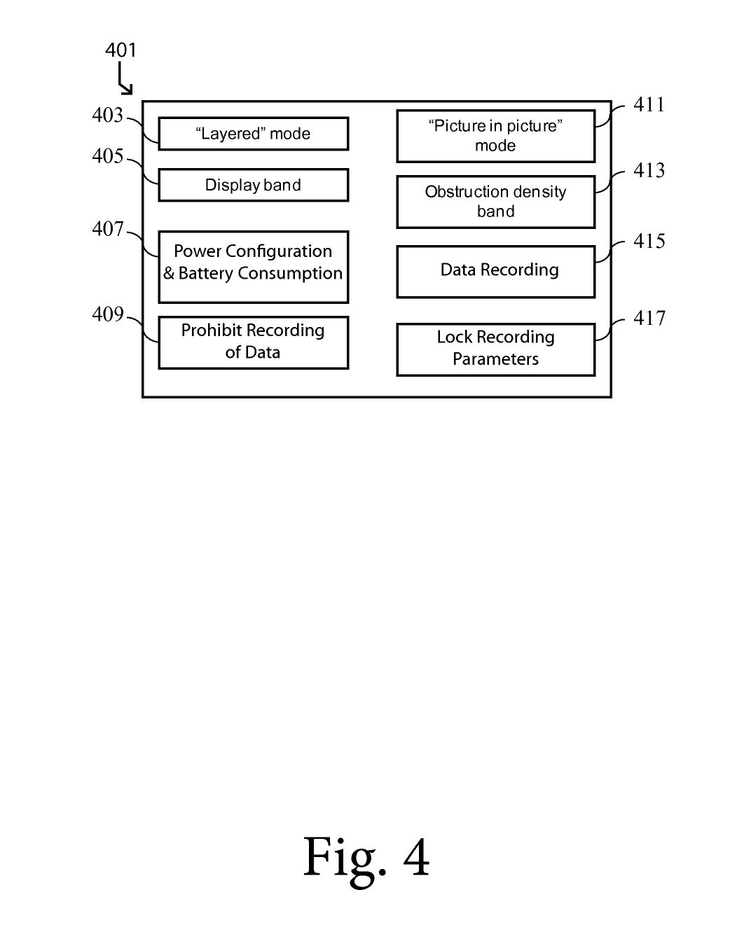

FIG. 4 is a schematic diagram illustrating the user interface 313 according to one embodiment of the present invention. The user interface 401 comprises any combination among a plurality of components. The plurality of components include: a “layered” mode 403 component, a “picture in picture” mode 411 component, a display band 405 component, an obstruction density band 413 component, a power configuration and battery consumption 407 component, for a data recording 415 component, a prohibit recording of data 409 component, and a lock recording parameters 417 component. The “layered” mode 403 incorporates a background layer for the display of information useful for collision avoidance and one or more application's primary interface in the foreground layer. Either the foreground or background layer may be made brighter or dimmer by varying the opacity of either. The “picture in picture” mode 411 is similar to what is found on televisions. The display band 405 is displayed at the top of the screen or can be repositioned by the user. The obstruction density band 413 is displayed at the top of screen or may be repositioned by the user. It works similar to the way radar systems display information. The user may adjust brightness and vary the opacity of the various information display elements. The power configuration and battery consumption 407 component may contain a low-power option that utilizes a different sensing or digital sampling algorithm, or user-configurable brightness or other parameters. The data recording 415 component records a variable amount of data received by the sensing mechanism. The prohibiting recording of data 409 component prohibits any recording of data received by the sensing mechanism. The lock recording parameters 417 locks data recording parameters in such a manner so that it would not be a user configurable option.

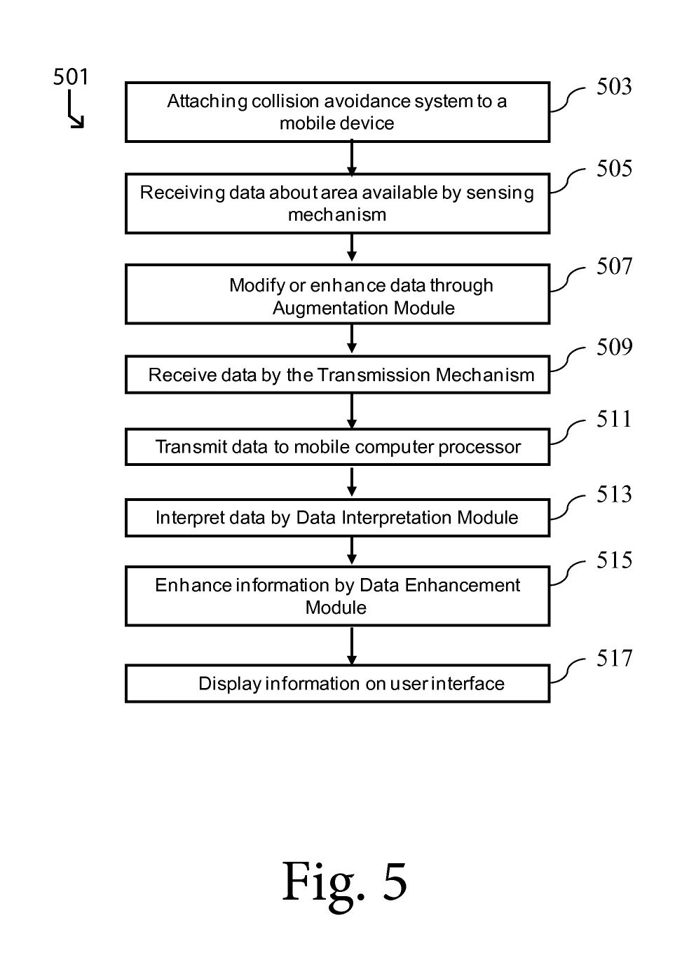

FIG. 5 is a flowchart illustrating a process for operating the collision avoidance system 101 according to one preferred embodiment of the present invention. The process for operating the collision avoidance system 501, comprising the following steps:

Step 503: Attaching collision avoidance system 101 to an electronic handheld device;

Step 505: Receiving data about area available by the sensing mechanism 103;

Step 507: Modifying or enhancing data available to the sensing mechanism 103 or as it is being received by the sensing mechanism 103 by the augmentation module for the sensing mechanism 109;

Step 509: Receiving data from the sensing mechanism 103 via the transmission mechanism 111;

Step 511: Transmitting data from the sensing mechanism 103 to the electronic handheld computing process via the transmission mechanism 111;

Step 513: Interpreting data being received from the transmission mechanism 111 by the data interpretation module 107 in the form of information that can be displayed back to the device user;

Step 515: Enhancing the information received from the sensing mechanism 103 by the data enhancement module 113 using additional information from the user or the device or additional data sources or additional applications; and

Step 517: Displaying information to the user via the user interface 115.

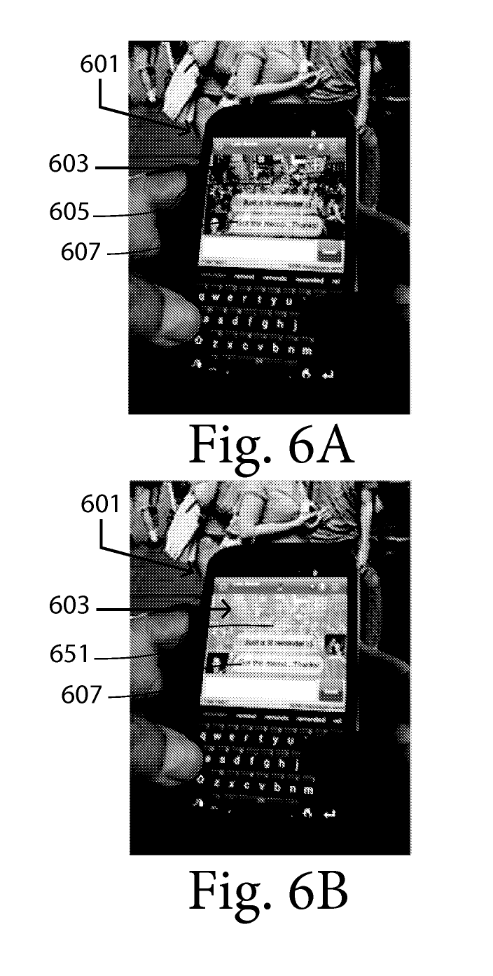

FIG. 6A and FIG. 6B are photographs of the collision avoidance system 601, which contains a user interface 603, which contains “layered” mode. The “layered” mode incorporates a background layer 605 for the display of information useful for collision avoidance and one or more application's primary interface in the foreground layer 607. In FIG. 6A, the background layer 605 is displayed with high brightness. In FIG. 6B, the background layer 651 is displayed with low brightness.

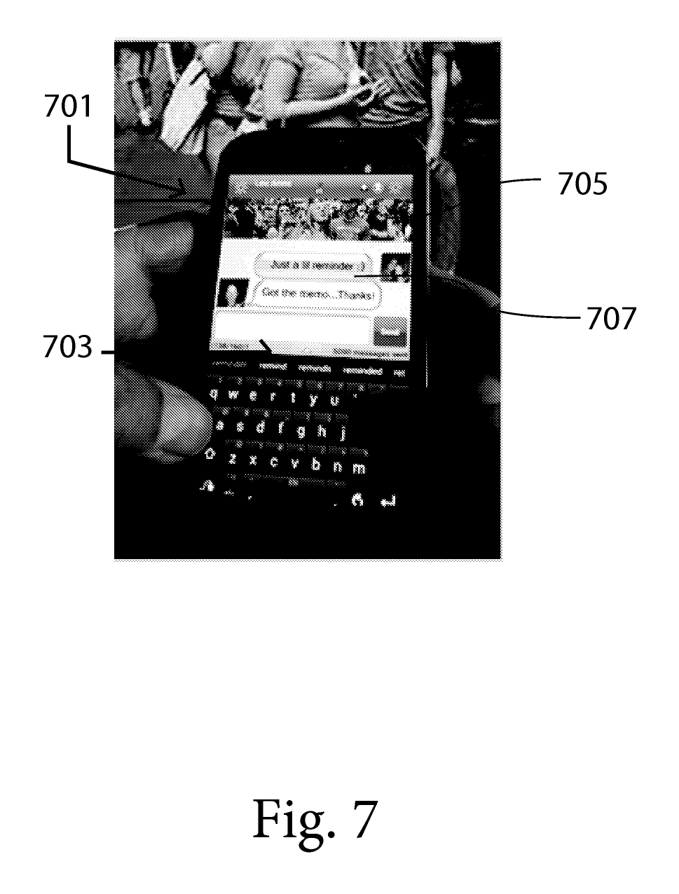

FIG. 7 is a photograph of a collision avoidance system 701, which contains a user interface 703, which contains a display band 705. The display band 705 is displayed at the top of the screen in this photograph. Underneath the display band 705, the user interacts normally with other phone applications 707.

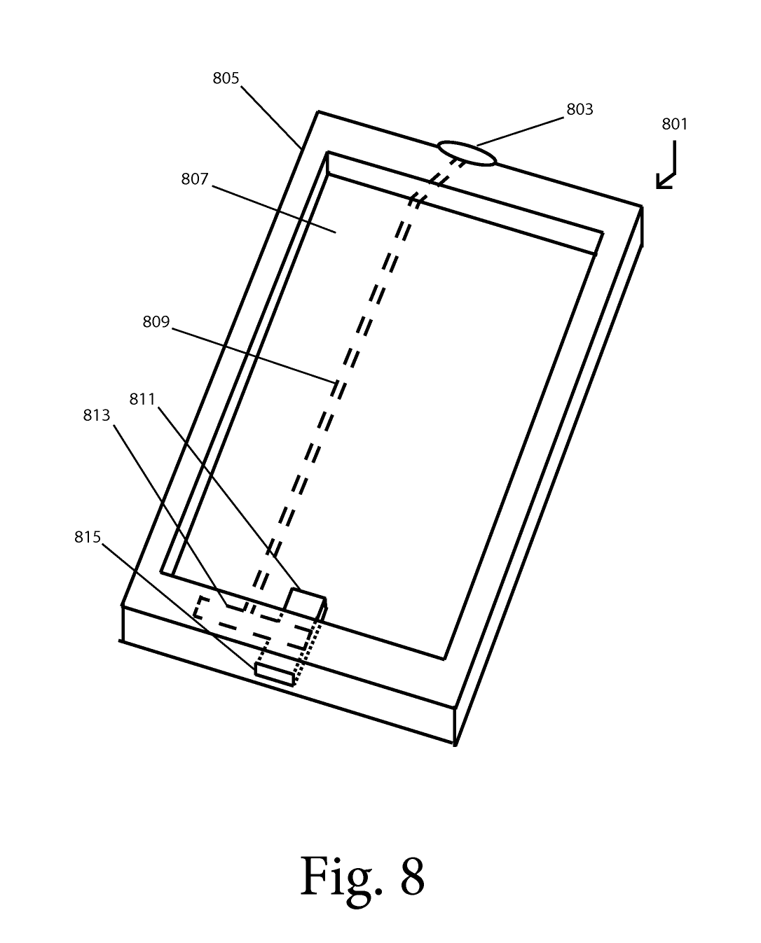

FIG. 8 is a schematic diagram illustrating a handheld device case 801 with a sensing mechanism 803 on top for avoiding collisions according to the present invention. The handheld device case 801 has an outer housing 805 and an inner housing 807 adapted for a specific electronic handheld device an internal connector 811 adapted for coupling to a specific electronic device such as a cell phone, an external connector 815 adapted for connecting to an external device such as a USB or Micro USB and the wiring 809 from the sensor 803 to circuitry 813 for operatively coupling the inner connector 811, external connector 815, and sensing mechanism 803.

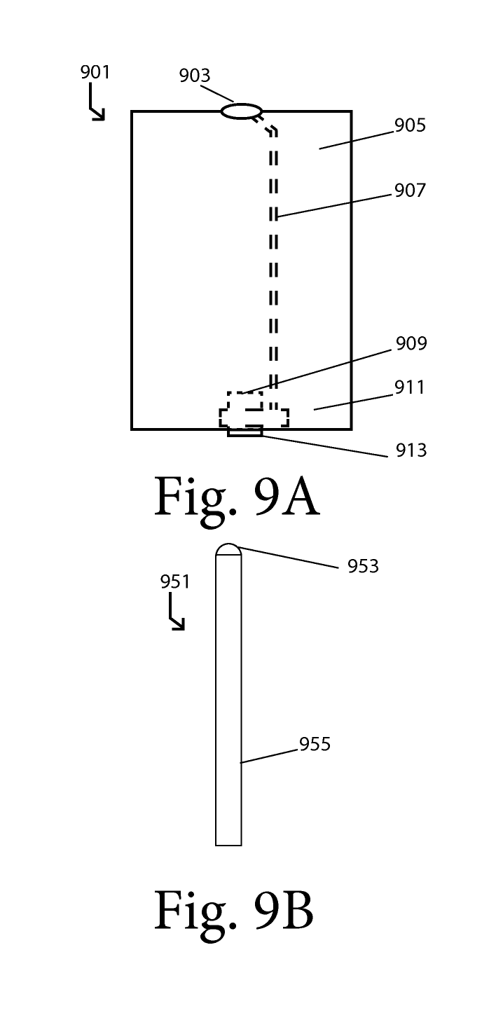

FIG. 9A is a schematic diagram illustrating a back view of a handheld electronic device case 901 with a sensing mechanism 903 on top for avoiding collisions according to the present invention. In this embodiment, the outer housing 905 extends around the back of the electronic device, and the sensing mechanism 903 on the top and extends to the back of the outer housing. This leaves the back outer housing 905 available for camera and camera flash openings which are not shown in FIG. 9A. This inside of the case has wires 907 that form around any openings, so the sensing mechanism 903 remains coupled to circuitry 911 that also couples with the inner connector 909 and the outer connector 913.

FIG. 9B is a schematic diagram illustrating a side view of a handheld electronic device case 951 with a sensing mechanism 953 on top for avoiding collisions according to the present invention. The outer housing 955 extends around the side of the handheld electronic device case 951. The side of the housing may have mountings or flaps available for providing access to buttons, slides, knobs, switches and other features which are not shown in FIG. 9B.

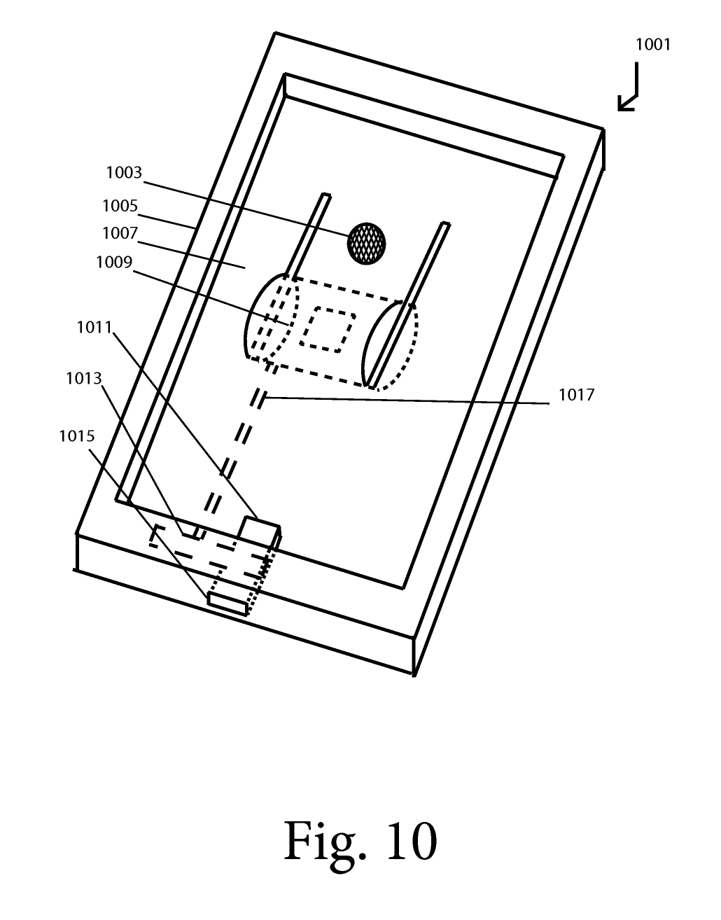

FIG. 10 is a schematic diagram illustrating an electronic handheld device case 1001 with a sensing mechanism 1009 independent of the electronic handheld device or a refracting mechanism 1009 dependent on the electronic handheld device's camera of the back for avoiding collisions according to the present invention. The electronic handheld device case 1001 may have a hole 1003 for the electronic handheld device camera's usage. The electronic handheld device case 1001 has an outer housing 1005 and an inner housing 1007 adapted for a specific electronic device. Positioning the sensing/refractor mechanism 1009 over the hole 1003, the On/Off switch is built into the sensing/refractor mechanism 1009 and enables the transmission of data through wire connector 1017 to circuitry 1013 for operatively coupling the internal connector 1011 and external connector 1015.

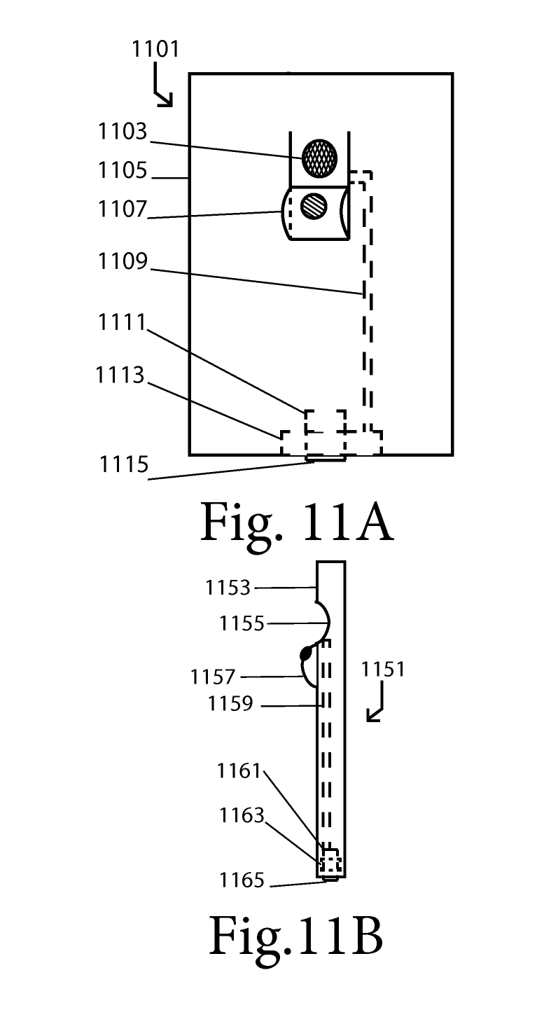

FIG. 11A is a schematic diagram illustrating a back view of a handheld electronic device case 1101 with a sensing/refracting mechanism 1107 on the back for avoiding collisions according to the present invention. The electronic handheld device case 1101 may have a hole 1103 for the electronic handheld device camera's usage. In this embodiment, the outer housing 1105 extends around the back of the electronic device, and the sensing/refracting mechanism 1107 is on the back of the outer housing. This provides a hole 1103 for camera and camera flash. The inside of the case has wires 1109 that form around any openings, so the sensing/refracting mechanism 1107 remains coupled to circuitry 1113 that also couples with the inner connector 1111 and the external connector 1115.

FIG. 11 B is a schematic diagram illustrating a side view of a handheld electronic device case 1151 with a sensing/refracting mechanism 1157 on the back for avoiding collisions according to the present invention. The outer housing 1155 extends around the side to the electronic handheld device case 1151. The side housing may have mountings or flaps available for providing access to buttons, slides, knobs, switches and other features which are not shown FIG. 11 B. The inside of the case has wires 1159 that form around any openings, so the sensing/refracting mechanism 1157 remains coupled to circuitry 1163 that also couples with the inner connector 1161 and the external connector 1165.

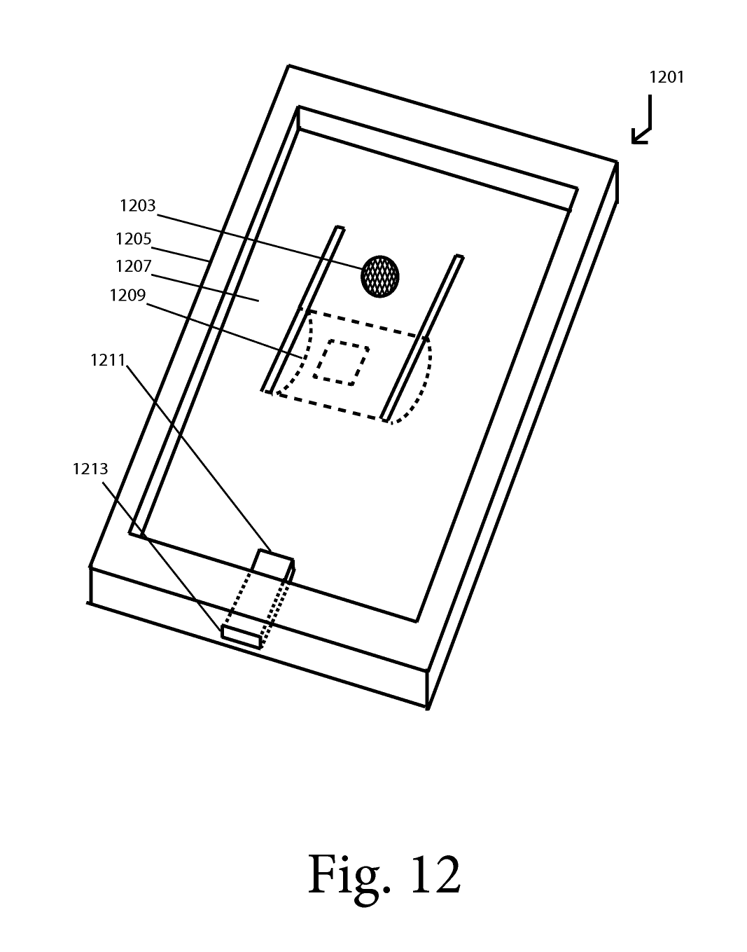

FIG. 12 is a schematic illustration of a handheld device case 1201 with a refracting mechanism 1209 which is dependent on the electronic device's camera on the back for avoiding collisions according to the present invention. The electronic handheld device case 1201 has an outer housing 1205 and an inner housing 1207 adapted for a specific electronic device. The electronic handheld device case 1201 has a hole 1203 for the electronic handheld device's camera usage. The electronic handheld device case 1201 has a refracting lens 1209, and optionally, a sliding mechanism. The electronic handheld device case 1201 has an internal connector 1211 to connect the electronic handheld device and an external connector 1213 to connect USB, Micro USB, or other proprietary connectors.

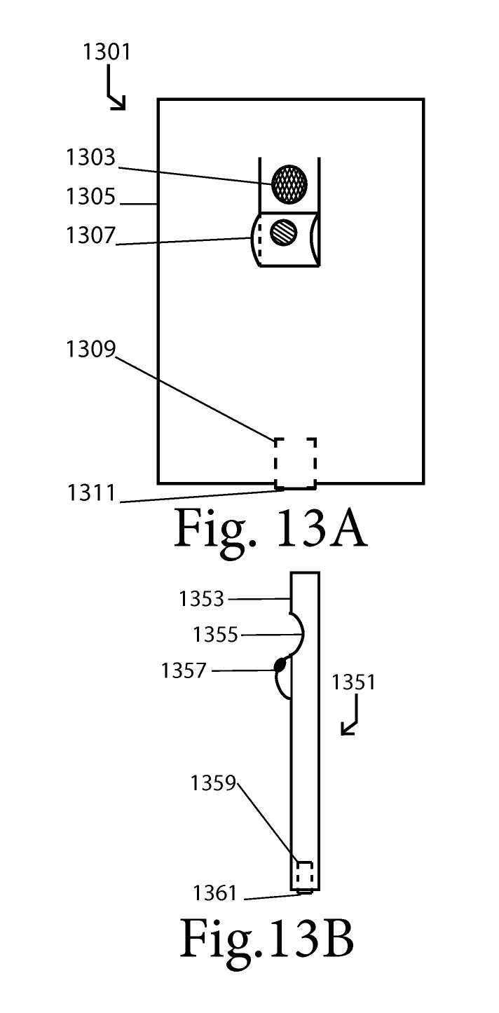

FIG. 13A is a schematic diagram illustrating a back view of an electronic handheld device case 1301 with a refracting mechanism 1307 on the back for avoiding collisions according to the present invention. In this embodiment, the outer housing 1305 extends around the back of the electronic device and the refracting mechanism 1307 is on the back of the outer housing. This provides a hole 1303 for camera and camera flash openings which are not shown in FIG. 13A. The electronic handheld device case 1301 has an inner connector 1309 and the external connector 1311.

FIG. 13B is a schematic diagram illustrating a side view of a handheld electronic device case 1351 with a refracting mechanism 1357 on the back for avoiding collisions according to the present invention. The outer housing 1355 extends around the side of the electronic handheld device case 1351. The side housing may have mountings or flaps available for providing access to buttons, slides, knobs, switches and other features which not shown in FIG. 13B. The electronic handheld device case 1301 has an inner connector 1359 and the external connector 1361.

While one or more embodiments of the present invention have been illustrated above, the skilled artisan will appreciate that modifications and adoptions to those embodiments may be made without departing from the scope and spirit of the present invention.

1. A collision avoidance system used in wireless telephonic and texting communications comprising:
a handheld electronic device having a display and wireless telephonic and texting capacities;
a sensing device integrated into said handheld electronic device for measuring the range of at least one obstacle from said handheld electronic device; and
a processor in said handheld electronic device for computing an obstacle's distance, said processor being operatively coupled to said sensing device;
wherein said processor calculates the rate of change of distance between said sensing device and said obstacle, estimating a time of intercept between said sensing device and said obstacle based on said rate.

2. The collision avoidance system of claim 1, wherein said display screen has touch screen capabilities.

3. The collision avoidance system of claim 1, wherein said touch screen has a display icon integrated into said display, alerting of a nearby obstruction.

4. The collision avoidance system of claim 1, wherein said sensing device further measures angle, and said processor estimates time of intercept additionally with path information based on said angle.

5. The collision avoidance system of claim 1, wherein said sensing device employs at least one camera.

6. The collision avoidance system of claim 1, wherein said sensing device employs radar.

7. The collision avoidance system of claim 6, wherein said sensing device employs a laser diode.

8. A collision avoidance system used in wireless telephonic and texting communications comprising:
a sensing device for measuring the range of at least one obstacle;
a connector, adapted for operatively coupling said sensing device to a handheld electronic device; and
a mounting device, adapted for attaching said sensing device to said handheld electronic device;
wherein said handheld electronic device has a display and wireless telephonic and texting capacities.

9. The collision avoidance system of claim 8, wherein said mounting device is adapted for top of said handheld electronic device.

10. The collision avoidance system of claim 9, wherein said mounting device offsets said sensing device by 25 to 35 degrees from a lateral access of said handheld electronic device.

11. The collision avoidance system of claim 9, wherein said mounting device offsets said sensing device by 30 degrees from a lateral access of said handheld electronic device.

12. The collision avoidance system of claim 8, wherein said mounting device is adapted for back of said handheld electronic device.

13. The collision avoidance system of claim 8, wherein said mounting device is a case for said handheld electronic device.

14. The collision avoidance system of claim 13, wherein said mounting device is a flap on a case for said handheld electronic device.

15. The collision avoidance system of claim 13, wherein said case has a processor operatively coupled to said sensing device and said connector.

16. A method of implementing a collision avoidance system operably installed in a handheld electronic device with a display and wireless telephonic and texting capacities, comprising the steps of:
accessing a sensing device for measuring a range of at least one obstacle;
storing said range;
calculating a rate of change of separation distance between said sensing device and said obstacle; and
estimating a time of intercept between the sensing device and the obstacle based on said rate.

17. The method of claim 16, further comprising the step of:
displaying an alert based on said estimation.

18. The method of claim 16, further comprising the step of:
displaying an alert utilizing a picture within a picture.

19. The method of claim 16, further comprising the step of:
displaying said estimation visually in an obstruction density band mode.

20. The method of claim 16, further comprising the step of:
displaying said obstruction density band through picture in picture.
